(19) United States
(12) Patent Application Publication
(10) Pub. No.: US 2024/0118668 A1
(43) Pub. Date: Apr. 11, 2024

(54) PROVISION OF CUSTOMIZED LOGIC FOR ORCHESTRATION

(71) Applicant: Schneider Electric USA, Inc., Andover, MA (US)

(72) Inventors: Ling Wu, Andover, MA (US); Alan Peter DeFreitas, Kensington, NH (US); Mickael Herve Robert Gouet, Medford, MA (US); Merrill Harriman, West Ossipee, NH (US)

(73) Assignee: Schneider Electric USA, Inc., Boston, MA (US)

(21) Appl. No.: 18/378,536

(22) Filed: Oct. 10, 2023

Related U.S. Application Data
(60) Provisional application No. 63/414,681, filed on Oct. 10, 2022.

(51) Int. Cl. G05B 15/02

(52) U.S. Cl. CPC G05B 15/02

(57) ABSTRACT

A method is provided for customizing orchestration of an industrial system infrastructure. The method includes receiving hardware user selections defining a plurality of hardware components of the industrial system infrastructure as a complete system, receiving application user selections defining applications to be deployed on the plurality of hardware components, receiving policy user selections defining rules for deployment of the plurality of hardware components and applications, and causing generation of logic that defines a plan for deployment of the applications on the plurality of hardware components in compliance with the rules for deployment, wherein the logic is configured to guide deployment of the applications on the plurality of hardware components.

### CROSS REFERENCE TO RELATED APPLICATIONS

This application claims priority to U.S. Provisional Patent Application Ser. No. 63/414,681 filed Oct. 10, 2022, which is incorporated herein by reference in its entirety.

### TECHNICAL FIELD

The present disclosure relates to orchestration of an industrial system infrastructure, and more particularly, to provision of customized logic for orchestration of the industrial system infrastructure.

### BACKGROUND

An orchestrator of an industrial system infrastructure uses a system state machine to perform orchestration tasks. The system state machine defines logic that can be used to deploy workloads and/or by the orchestrator. The system state machine depends on the industrial system infrastructure's hardware components and workloads that need to be deployed on and executed by the hardware components. The system state machine for each industrial system infrastructure used for deployment and/or orchestration of each industrial system infrastructure can be different, Additionally, orchestration needs for a particular industrial system infrastructure can change over time.

Developers create system state states and the defined logic for orchestrator and/or deployment. The developers need skill and expertise to create system state diagrams that enforce various orchestration policy rules, such as high availability or failure recovery. Logic defined by the system state machine can be hard coded in the orchestrator. A minor change to the logic, such as due to a change in policy by its business overseers, can require developers to review and understand the code that is hard coded in the orchestrator in order to implement changes. Maintenance of the orchestrator consumes a great amount of time and resources.

Additionally, the logic used by each orchestrator is not transferable between industrial system infrastructures that have different policy rules, physical components and/or use different workloads.

While current systems and methods have performed adequately, there is still a need in the art for simplifying the process of developing and adjusting logic used by an orchestrator. There is also a need in the art to for an orchestrator that can be configured for use with different industrial system infrastructures that have different policy rules and/or requirements.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings. To achieve these and other advantages and in accordance with the purpose of the illustrated embodiments, in one aspect, disclosed is a computer-implemented method for customizing orchestration of an industrial system infrastructure. The method includes receiving hardware user selections defining a plurality of hardware components of the industrial system infrastructure as a complete system, receiving application user selections defining applications to be deployed on the plurality of hardware components, receiving policy user selections defining rules for deployment of the plurality of hardware components and applications, causing generation of logic that defines a plan for deployment of the applications on the plurality of hardware components in compliance with the rules for deployment, wherein the logic is configured to guide deployment of the applications on the plurality of hardware components.

In one or more embodiments, the method can further include outputting the logic to guide the deployment of the applications on the plurality of hardware components.

In one or more embodiments, the method can further include providing a graphical user interface (GUI) for receiving the hardware user selections, the application user selections, and the policy user selections, and the GUI allows a user to select the hardware user selections, application user selections, and policy user selections from one or more repositories of information.

In one or more embodiments, the hardware user selections can define connections between hardware components and the topology can indicate how the hardware components are connected with each other.

In one or more embodiments, the method can further include performing a cross-validation process, which can include validating the hardware user selections, the application user selections, and the policy user selections in view of one another.

In one or more embodiments, the method can further include prompting a user to revise one or more of the hardware user selections, the application user selections, and the policy user selections, followed by repeating the cross-validation process.

In one or more embodiments, the method can further include optimizing the logic to best satisfy one or more optimization goals before outputting the logic.

In one or more embodiments, the one or more optimization goals are included in the policy user selections.

In one or more embodiments, the method can further include individually validating the hardware user selections, the application user selections, and/or the policy user selections.

In one or more embodiments, the method can further include receiving notification of a problem associated with the industrial system infrastructure and causing the cross-validation process to be repeated responsive to receipt of the notification of the problem, and causing the generation of the logic to be repeated.

In one or more embodiments, the method can further include receiving an update to at least one of the hardware user selections, the application user selections, and the policy user selections, causing the cross-validation process to be repeated responsive to receipt of the update, and causing the generation of the logic to be repeated.

In accordance with another aspect of the disclosure, a system for customizing orchestration of the industrial system infrastructure is provided. The system includes a memory configured to store programmable instructions and a processing device in communication with the memory, wherein the processing device, upon execution of the programmable instructions is configured to perform the disclosed method.

In accordance with still a further aspect of the disclosure, a non-transitory computer readable storage medium and one or more computer programs embedded therein is provided, which when executed by a computer system, cause the computer system to perform the disclosed method.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1 is a block diagram illustrating an example orchestration system, in accordance with embodiments of the disclosure.

FIG. 2 is a flowchart showing an example method for providing customized logic for orchestration of an industrial system infrastructure, in accordance with embodiments of the disclosure; and

FIG. 3 is a block diagram of an exemplary processing system that could be used to implement a method for providing customized logic for orchestration of an industrial system infrastructure, in accordance with embodiments of the disclosure.

Identical reference numerals have been used, where possible, to designate identical elements that are common to the figures. However, elements disclosed in one embodiment may be beneficially utilized on other embodiments without specific recitation.

### DETAILED DESCRIPTION

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth. It is to be appreciated the embodiments of this disclosure as discussed below are implemented using a software algorithm, program, or code that can reside on a computer useable medium for enabling execution on a machine having a computer processor. The machine can include memory storage configured to provide output from execution of the computer algorithm or program.

As used herein, the term “software” is meant to be synonymous with any logic, code, or program that can be executed by a processor of a host computer, regardless of whether the implementation is in hardware, firmware or as a software computer product available on a memory storage device or for download from a remote machine. The embodiments described herein include such software to implement the equations, relationships, and algorithms described above. One skilled in the art will appreciate further features and advantages of the disclosure based on the above-described embodiments. Accordingly, the disclosure is not to be limited by what has been particularly shown and described, except as indicated by the appended claims.

The disclosure is directed automation of and standardization of a process for generating a desired state machine and/or logic for use by an orchestrator of an industrial system infrastructure. An intake tool frontend is provided that enables a user to input hardware and its configuration and to build a topology that includes the hardware components and indicates connections between the hardware components. The intake tool further enables a user to enter applications and their configuration, as well as orchestration policies to be applied. The intake tool frontend can include a user-friendly and graphical user interface (GUI). The user can use the intake tool frontend to build the topology or import a topology from another standard topology format.

The topology is processed by an orchestration service backend to generate logic, such as in the form of a system state machine that defines the logic. The logic can be used by a deployment service backend and/or an orchestration process to control deployment of the applications on the hardware in compliance with the policy rules of the topology.

The system state machine or logic can be optimized by one or more optimization algorithms in accordance with one or more optimization criterium (referred to as optimization criteria). The optimization criteria can be included in the policy received by the user intake frontend.

The deployment service backend can be included within, for example, a computer integrated management system (CIMS) that accesses orchestration processes for implementing the logic and/or the system state machine and controlling the deployment of the applications.

The deployed system can be displayed to the user via a display tool frontend. The display tool frontend can include interactive widgets that a user can interact with for interacting with the orchestration service backend and/or deployment service backend.

An automated process is provided in which a user can modify, via the intake tool and at any time, the topology, hardware configurations, applications and their configurations, and the policy rules. These modifications are automatically processed for generating or updating the system state machine. The updated system state machine can be used to perform or modify the deployment within the industrial system infrastructure at any time and/or update the logic used by the orchestrator.

In one or more embodiments, services provided by the intake tool frontend, display tool frontend, orchestration service backend, and/or deployment service backend can be cloud-based services. The cloud-based services can be included with an enterprise network or can connect with one or more different enterprise networks.

The cloud-based services can be used by different industrial system infrastructures. Each industrial system infrastructure and its users can access the cloud-based services to configure a customized topology or to update the topology for that industrial system infrastructure. Once the updates to the topology are entered, a system state machine can be automatically output to the backend deployment service. This allows different business owners to use the cloud-based services to create different system state machines that are available to be used for orchestration of their industrial system infrastructure.

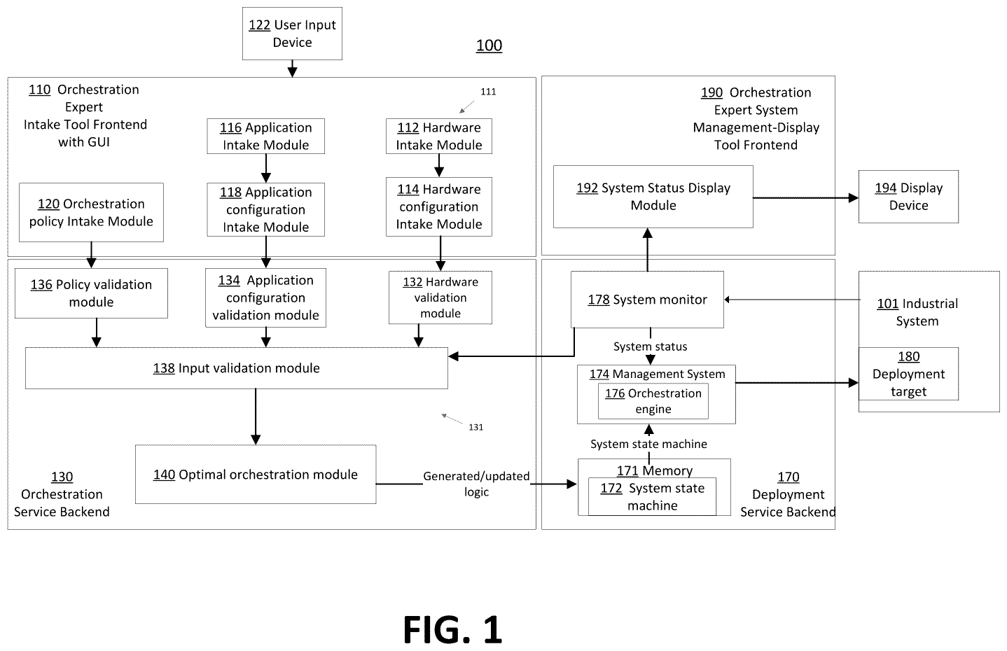

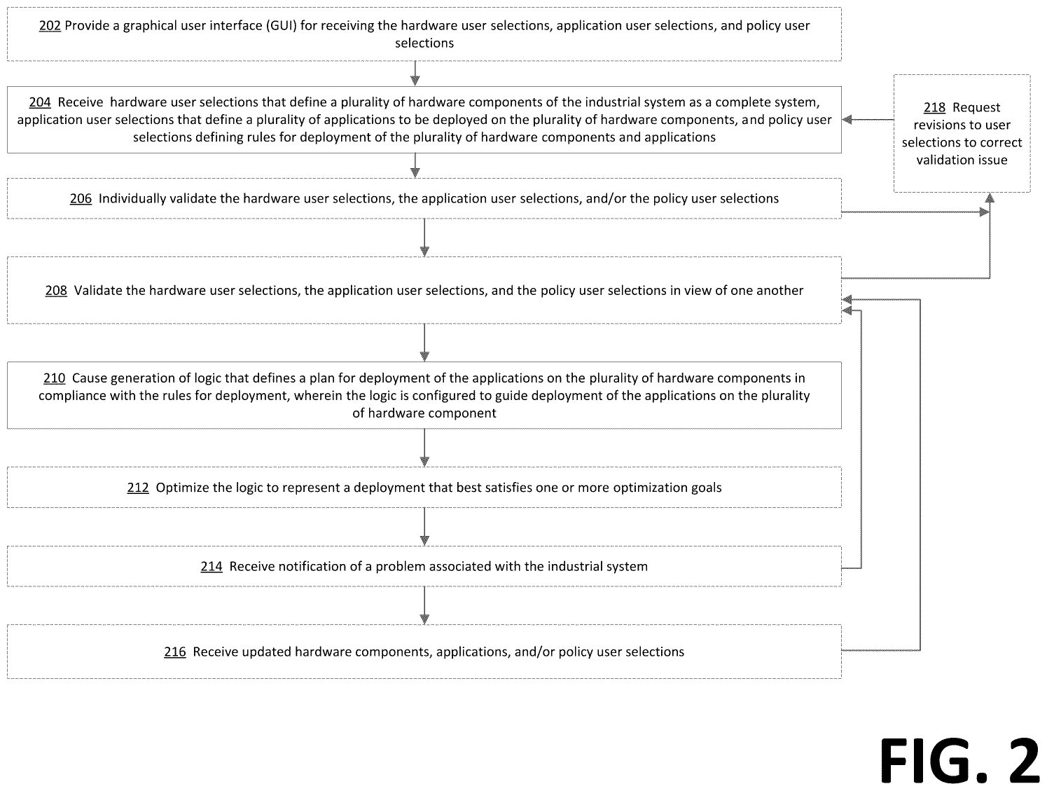

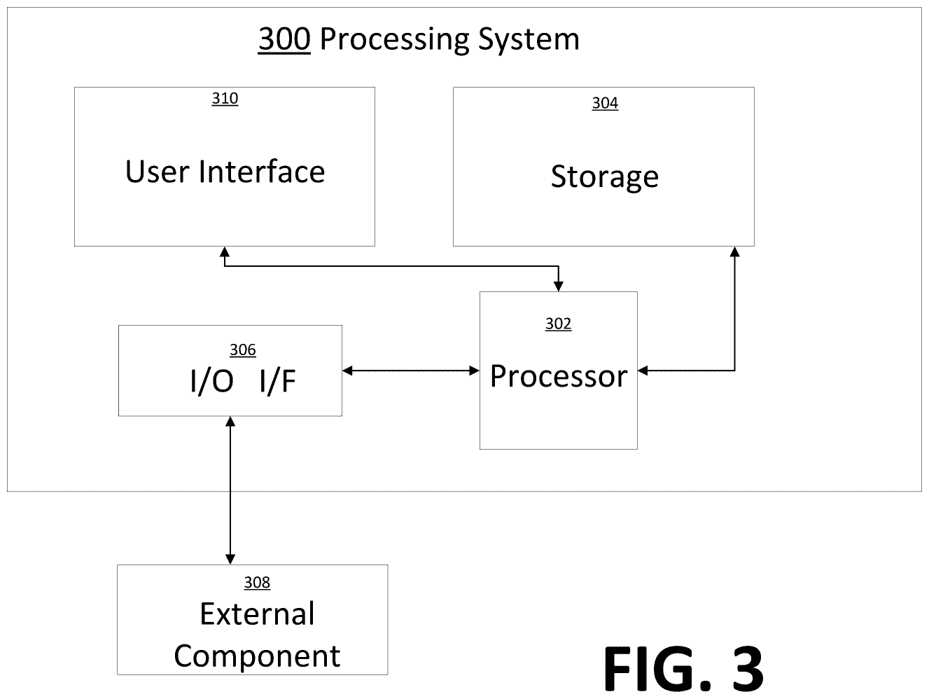

Reference will now be made to the drawings wherein like reference numerals identify similar structural features or aspects of the subject disclosure. For purposes of explanation and illustration, and not limitation, a block diagram of an exemplary embodiment of an orchestration system for an industrial system infrastructure in accordance with the disclosure is shown in FIG. 1 and is designated generally by reference character 100. Other embodiments of orchestration system 100 in accordance with the disclosure, or aspects thereof, are provided in FIGS. 2, and 3, as will be described.

The following patent application and patent publications, which are assigned to Schneider Electric Industries SAS, describe aspects of presentation and updating of a topology and deployment and management of assets in an industrial system infrastructure, and are each incorporated herein by reference in their entirety: U.S. Ser. No. 10/845,786B2, U.S. Ser. No. 11/079,744B2, U.S. Ser. No. 11/579,595B2, US20210356944A1, and US20230161332A1.

Industrial system infrastructure 101 can be, for example and without limitation, a refinery system, a chemical production system, an electronics manufacturing system, a vehicle production system, etc. The industrial system infrastructure includes multiple sub-infrastructures, including a physical infrastructure, virtual infrastructure and network infrastructure. of the industrial system infrastructure. The physical infrastructure includes physical nodes that can be connected to one another. The physical nodes and relationships between the physical nodes are defined by a topology. Software and/or workloads can be deployed on the physical nodes in a nonvirtual manner. A physical node is a hardware component, and can include a combination of one or more memories, one or more processors, and firmware. Software can be stored in the memory for execution by the processor(s), also referred to as deployment.

The virtual infrastructure includes applications that define virtual nodes, such as virtual machines, containers, workloads to configure firmware of the physical nodes, clusters of containers. A virtual node can be deployed on a hardware component or on another virtual node.

The network infrastructure includes network nodes that can include dumb and/or smart network components that provide communication between any combination of physical nodes, their software, and virtual nodes. The network nodes include hardware components. The hardware components of smart network components also include one or more memories and one or more processors. Applications, including software applications or virtual nodes can be deployed on the smart network components.

The desired system state models the industrial system infrastructure by defining two or more of the physical, virtual, and network infrastructures. The desired system state defines nodes (physical, virtual or network nodes), their configurations, and relationships between any combination of the hardware components (of the physical and/or network infrastructures) and the applications of the virtual infrastructure as well as of at least one of the physical and network infrastructures. The configuration and relationships can be represented, for example, by metadata.

Industrial system infrastructure 101 has assets, including hardware components (physical assets) and applications (e.g., software, virtual, logical assets). Orchestration system 100 includes an intake tool frontend 110, an orchestration service backend 130, a deployment service backend 170, and a display tool frontend 190.

Intake tool frontend 110 includes intake modules 111, including a hardware intake module 112, a hardware configuration intake module 114, an application intake module 116, an application configuration module 118, and optionally an orchestration policy intake module 120. Hardware intake module 112 and hardware configuration intake module 113 allow a user to enter and/or update hardware component assets of an industrial system infrastructure 101, to specify connections between the hardware components, and to specify configuration of the hardware components. The user can build or update a topology of industrial system infrastructure 101 by inputting information via intake modules 111. The topology indicates the hardware components and any connections between these hardware components.

Application intake module 116 and application configuration intake module 118 allow the user to enter and/or update application assets to be used by industrial system infrastructure 101 and to specify configuration of the applications. Optionally, orchestration policy intake module 120 allows the user to enter orchestration policy rules to be applied to industrial system infrastructure 101. When orchestration policy rules are not entered by the user, default orchestration policy rules can be used.

Intake modules 111 can omit specifying relationships between the applications and the hardware modules, such as on which hardware component an application is deployed. These relationships can be determined by orchestration service backend 130 using the topology provided.

The hardware components are physical modules that are usable by the industrial system infrastructure once applications are deployed on the physical modules. The hardware components can include an operating system, or can be simple devices (e.g.,— sensors, simple actuators, simple input/output (I/O) modules) that do not require an operating system. Some examples of hardware components include controllers (e.g., microcontrollers, programmable logic controllers (PLCs)), edge devices, servers, field devices (e.g., sensors, actuators, alarms), network devices (e.g., switches, probes, monitors, etc.), inter-process communication (IPC), small single-board computers (such as a Raspberry Pi™), etc.

A portion or all of the hardware components can be on-premises, allowing industrial system infrastructure 101 to be air gapped from any networks that are not on-premises. In one or more embodiments, the hardware components can include remote hardware components. All or a portion of the hardware components can be always connected to an off-premises network, intermittently or periodically connected to the off-premises network (e.g., once per day or week), or air-gapped and never connected to the to the off-premises network.

The applications can include software (e.g., web applications, database(s)), control applications for controllers, and/or containerized applications (e.g., Docker™ or Kubernetes™ workloads) that can be deployed on hardware components. The applications can include one or more virtual controllers (e.g., virtual PLCs or distributed programmable automation controllers (DPACs). The applications can include logical assets (e.g., host, computer node, cluster, etc.) or virtual assets (e.g., a software service, a virtual PLC, a computer application, an AI engine, virtual machines, Docker continers, Kubernetes workloads, containers, container clusters, and/or web assemblies (WASM) etc.).

The orchestration policy rules define policies for industrial system infrastructure 101. The policy rules are used to define logic that defines a plan for deployment of the applications on the hardware components, requirements for behavior or conditions of the hardware components and/or applications after deployment, and optimization criteria. The industrial system infrastructure is caused to be configured to abide by these policies. The policies can include, for example, system configuration rules, orchestration rules, and optimization goal rules.

The system configuration rules can define relationships between the assets in addition to the physical relationships defined by the topology, such as for the physical assets, network assets, virtual assets, and logical assets.

The orchestration rules can include, for example and without limitation, rules for high availability, recovery from fault or failure, load balancing (even or weighted), and cyber event response. For example, policy rules for a cyber event response would cause a response in the event of a cyberattack that comprises industrial system infrastructure 101, such as by causing affected hosts (physical or virtual) to be sandboxed, critical workloads to be moved to other hosts in order to isolate the problem in industrial system infrastructure 101's network. In one or more embodiments, the policy rules can cause establishment of a server to behave as a honeypot for the cyberattack to distract the attack.

The rules can also include optimization goals for optimization of deployment of the applications on the hardware components. An optimization goal can include, for example, a minimum or maximum number of devices to be used and/or whether load should be evenly distributed through all the devices, a minimum or maximum percentage of CPU and/or memory consumption, minimum or maximum of device temperature if temperature data is available, etc. Intake modules 111 can provide a user-friendly graphic user interface (GUI) that allows the customer to build the topology of industrial system infrastructure 101. The GUI can include a separate GUI for each of hardware intake module 112, hardware configuration intake module 114, application intake module 116, application configuration intake module 118, and orchestration policy intake module 120 and/or an integrated GUI for two or more of the individual intake modules 112, 114, 116, 118, 120. The GUI can allow the user to establish a connection or relationship between two or more hardware components. For example, the user can draw a line as a connector between two hardware components to indicate that these two hardware components are physically connected in the topology. For example, the two hardware components can be connected by a cable of the network.

The user can specify which protocol is used for this connection (e.g., Ethernet protocol). The line representing a connection of a device to a network switch using an Ethernet cable can have associated metadata (e.g., visible when hovering on the line) that indicates that TCP/IP is used as the protocol for communication between the device and the network switch. The user can draw lines to build each of the connections between the hardware components of the topology.

The user can enter assets (meaning hardware components or applications) and policy rules and configure their properties via the GUI, including specifying whether the asset is a hardware component or an application. The GUI can provide one or more asset menus via which the user can make asset selections. Menus provided by the GUI can be nested. Upon selection of a particular hardware component of application from the asset menu(s), the user can be provided with one or more configuration menus by the corresponding hardware configuration intake module 114 for selecting parameters of the hardware component to provide its configuration or application configuration intake module 118 for selecting parameters of the application to provide its configuration. Parameters that are not configured use default values.

The asset and configuration menus can access one or more libraries, to provide one or more dropdown lists (which can also be menus). The libraries can be searchable and can optionally be filterable by features. Some example features, without limitation are memory capacity or number of cores for hardware components, and container application type, workload type, or software type for applications. An example library is a library of general purpose hardware devices. A user can select a hardware device (e.g., a Raspberry Pi, etc.) from drop down lists derived from this hardware devices library and can further add hardware specifications for the selected hardware device from further dropdown lists. Hardware device selections, configured with their respective hardware specifications, are added to the topology in a standardized format. When adding to the topology a special hardware device that does not yet exist in the libraries and dropdown lists, the user can create a profile for the special hardware device by providing specifications of the hardware (e.g., vendor name, model name, CPU properties, memory properties, etc.). Each of the special hardware devices can be included in a library or can be added as a new entry to a library (such as with administrator approval). The user may determine this information from the actual special hardware device's specifications.

A library of virtualized asset sources can define classes, such as an instance relationship. The definitions can define a workload. Once selected by the user, the definition can be used to create an instance of the workload as an application user selection than is available to be deployed, for example, on a host as a container or virtual machine.

The specifications may each be selected from one or more additional repositories of information (such as libraries or databases) and/or can be added as a new entry to the libraries (perhaps subject to user approval). The specifications can be available for generic categories, such as CPU, memory, serial number, manufacture name, etc. A need for addition of a new entry to a category can arise when that entry does not yet exist in the library. The information from the libraries and repositories of information can be standardized or can be converted into a standardized format used by the topology. In this way, the user-selected hardware components and applications are entered into the topology using the standardized format. The standardized format can be provided by the library selection(s). Regarding user selection of the applications, libraries can be provided for containers, software, and control applications. An example library can include a collection of control applications (also referred to as workloads). The library can be accessed by a menu selection. Entries in the library can be accessed via one or more dropdown lists provided by the menu. The user can then select an application from the dropdown lists. The control applications may have been generated, for example, by control engineers. An example program used for generating the control applications is EcoStruxure Automation Expert™ (EAE) and imported into the library. The library entries can have associated properties that the user can define, such as environment in which it is used, or criteria used for execution.

In this way, the user-selected and configured assets can be entered into the topology using a standardized format. Libraries can be provided of fully assembled hardware components, sub-components for assembling into hardware component, software programs, control applications (e.g., workloads), etc. An example of a subcomponent in a subcomponent library is a particular driver that is needed under circumstances, such as a graphics processor driver that is needed to run an AI application in a software library that could potentially be run on an IPC in a hardware library.

The logic can be created manually. In one or more embodiments, the logic can be generated automatically from the user-entered topology, applications, and policy rules. Standardized libraries can be provided from which the user can select the hardware components and their connections (for generating the topology), the applications, and the policy rules. The logic can be automatically created by automatically creating each possible deployment plan, wherein each possible deployment plan is a candidate. The candidate deployment plans can be in a standardized format (such as represented as a table). A standardized set of conditions can be provided in a library. A deployment plans for each candidate can be generated for respective variations of each different condition. A condition can be, for example ambient temp, with variations of the ambient temperature including temperatures A, B, C. The orchestration policy can define conditions and variations to use. For each candidate deployment plan, the candidate deployment plan is checked to see if it complies with the policy rules as the respective conditions are varied. Candidate deployment plans that do not comply with the policy rules as the conditions are changed can be removed. Each candidate deployment plan, the conditions, and variations can be combined into a state machine, which is the logic.

The logic generated for each of the candidate deployment plans are evaluated by the optimization algorithms. Each optimization algorithm can give a score. The score can take into consideration the variations in conditions in view of the optimization goal(s). A composite score can be generated if multiple optimization algorithms are used. The candidate deployment plan having the best score is selected. The logic for the selected candidate deployment logic is provided in a format that can be deployed by the orchestration engine (e.g., orchestration engine 176). User intervention can be allowed for any of the steps, such as to make selections or approve automated selections. The degree of allowed or required user intervention can be configurable.

The logic can be represented using a language, such as TOSCA, that uses an ontology that is usable by orchestration engine 176. For example, in a language such as TOSCA, the logic can include lists of deployed containers, firmware version, CPU temperature, network interface status, application recorded response times, etc.

The system state machine can be represented as a digital twin that is a digital representation of assets of industrial system infrastructure 101. The digital twin can include asset metadata having references, for example and without limitation, to dependent artifacts, enumeration of application programming interfaces (APIs), call out services for interfacing to the asset, relationship between the assets of industrial system infrastructure 101, asset instance policy information, and asset specific orchestration workflows.

Depending on which policy rules are selected (or when default policy rules are applied), the GUI for user selection of hardware components and applications may add features for configuration of the hardware components and applications to require the user to configure the hardware components and applications based on the policy rules being applied. For example, when policy rules require high availability (per user selection or default), the GUI for configuration of work nodes (whether the work node is a hardware component or an application) may require role assignment of primary, secondary, and/or spare for implementation of high availability. The GUI can require that all required role assignments required by the high availability feature be provided. These features are included in the topology in a standardized format.

Regarding user selection of the policy rules, the menus can access a library of policy rules to provide one or more dropdown lists via which a user can select policy rules and their properties (e.g., by specifying a quantitative values for requirements, thresholds, etc. The selected policy rules are added to the topology in a standardized format.

As described, intake tool frontend 110 provides a tool for users to build a topology having a standardized format of industrial system infrastructure 101. The libraries can be customized for a particular industrial system infrastructure or field of use of industrial system infrastructure 101 (e.g., refinery system, chemical production system, electronics manufacturing system, vehicle production system, etc.).

When the user has completed adding assets and rules to the topology, the information entered via intake tool frontend 110 is submitted to orchestration service backend 130 for validation and processing. The user can cause this submission by selecting a designated graphical button on the GUI or the submission can be autonomous once it is confirmed that the process of building or updating the topology has been completed. This topology represents a desired topology of the industrial system infrastructure 101 as a complete (e.g., global) industrial system infrastructure.

The term “complete” with reference to the industrial system infrastructure refers to an integration of hardware components and a plurality of applications deployed on the hardware components in compliance with the policy rules, wherein, when in operation, when the applications are deployed on the hardware components and the applications are executed, the hardware components and the applications cooperate for the complete industrial system infrastructure to perform its tasks as defined in the applications. Examples of tasks include providing control, providing monitoring, providing communication, providing a local or cloud-based service, using a local or cloud-based service, etc. Actions executed (that are controlled, monitored, etc.) can include moving an object with a mechanical arm, filling a bottle with milk, taking a picture for image processing, etc. The complete industrial system infrastructure can include a plurality of subsystems performing multiple tasks. The complete industrial system infrastructure is not limited to a cluster and/or associated hosts of the cluster. The complete industrial system infrastructure can include all of its hardware components and applications. This can include networked assets within industrial system infrastructure 101 and or its control system, including but not limited to servers, IPCs, PLCs, drives, I/O, sensors, actuators, cameras, gateways, routers, switches, etc.

The set of hardware components and the plurality of applications deployed on the hardware components can be integrated such that a change to the hardware components (such as addition of a new hardware component, misfunction or failure of a hardware component, upgrade of a hardware component) would affect other hardware components, would cause a need to change deployment of the applications, and/or would cause a need to update the policy. A change to an application (such as deployment of a new application on a hardware component, misfunction or failure of an application, upgrade of an application) would affect other applications, would cause a need to change deployment of the applications, would cause a need to change or upgrade a hardware component, and/or would cause a need to update the policy. A change in the policy would cause a need to upgrade or change deployment of the hardware components and/or the applications.

The integration of the complete industrial system infrastructure can also be defined by an integration of hardware components and applications from the virtual infrastructure as well as at least one of the physical infrastructure and network infrastructure. Changes in one of these infrastructure affects the other infrastructure. Changes in the logic affect one or more of the infrastructure.
the industrial system infrastructure is not limited to a cluster and/or associated hosts of the cluster. The desired state and current state of the industrial system infrastructure can model all of its hardware components and applications or a portion of them. This can include all or a portion of the hardware components and software components of any combination of the physical infrastructure, virtual infrastructure and network infrastructure. Networked assets within industrial system infrastructure 101 include, but are not limited to servers, interprocess communications (IPCs), programmable logic controllers (PLCs), drives, I/O interfaces, sensors, actuators, cameras gateways, routers, switches, etc.

Orchestration service backend 130 includes validation modules 131 and optimal orchestration module 140. Validation modules 131 includes hardware validation module 132, application validation module 134, policy validation module 136, and/or input validation module 138. When any of the validation modules 131 are not provided, validation can be performed manually. When validation modules 131 are all provided, output from intake tool frontend 110 can be autonomously provided to optimal orchestration module 140, meaning without user intervention, or can be automatically provided, albeit with requests for user input (such as for approval of a validation or a request for a correction of an invalid input). The degree of user intervention needed or allowed can be configurable.

Hardware validation module 132 applies validation rules to determine if the hardware components and their configuration input via hardware intake module 112 and hardware configuration intake module 114 are valid. For example, one or more hardware components entered via hardware intake module 112 could be determined invalid, for example and without limitation due to the same IP address being used by multiple hardware components. A configuration applied to a hardware component via hardware configuration intake module 114 can be invalid, for example, when the configuration is not compatible with the hardware component to which it is applied (e.g., uses resources (an amount of memory, ports, special processor, computation speed) that the hardware component does not have, connects hardware components that are not compatible, etc.).

One or more application components entered via application intake module 116 could be determined invalid by application validation module 134, such as due to an invalid digital signature (which could be an indicator of tampering or generation by an unauthorized party, since digital signatures are used to ensure authenticity). A configuration applied to an application component via application configuration intake module 118 be can invalid by application invalidation module 134, for example, when the configuration is not compatible with the application to which it is applied (e.g., uses a data format that is not compatible with the application, uses a protocol which the application cannot use, etc.).

A policy entered via orchestration policy intake module 120 can be determined to be invalid by policy validation module 136, such as due to a conflict. For example, a conflict can arise when a first rule requests duplication of an application running on a different hardware component, and a second rule requires that the application run with a Static IP address. The conflict would arise because networks do not allow the same IP address to be used on different hardware components.

Input validation module 138 cross-validates the input applications, hardware components, and policy rules. An example of an incompatibility that would not be cross validated would arise when an application is configured to require that a hardware component upon which it will be deployed use a specific operating system (OS), such as Ubuntu™ 22.04 or above, however the only hardware components otherwise capable of running the application are configured to use Ubuntu 20.04. This incompatibility can cause a conflict message to pop up on the user interface and request a system administrator to upgrade the OS used by the hardware component. Another example of an incompatibility that would not be cross validated would arise when an application is configured to require that a hardware component upon which it will be deployed use Ubuntu with a PRERMPT_RT patch, however the only hardware components otherwise capable of running the application are configured without the PREEMPT_RT patch. Another example of a cross-validation conflict includes a high availability policy that requires duplication of an application on two different hardware components, however the application requires a hardware component having at least six cores, while only one device among the available hardware components has six cores, causing satisfaction of the high availability policy requirement to be impossible. In one or more embodiments, if input validation module 138 is omitted, this information can be provided manually to optimal orchestration module 140. When invalid input is detected by validation modules 131, the user can be notified (e.g., by a user interface of orchestration service backend 130, such as by a pop-up window). The user can review the invalid inputs and return to the intake tool frontend 110's GUI to modify the inputs.

Input validation module 138 outputs a validated topology (that includes the validated hardware component selections), the validated application selections, and the validated policy rules (all which correspond to the complete industrial system infrastructure) to optimal orchestration module 140. Optimal orchestration module 140 is configured to generate logic that can be used for orchestration from the standardized topology, application selections, and policy selections of the complete industrial system infrastructure 101. The logic can be provided in the form of a system state machine, but is not limited to a specific format. The format can be compatible with the deployment service backend 170 so that the logic can be implemented, e.g., by deploying the assets.

Optimal orchestration module 140 further optimizes the logic by using one or more optimization algorithms. The logic represents an optimized plan for deployment of the applications on the hardware components of industrial system infrastructure 101in compliance with the policy rules.

Many candidate deployment plans are considered, each candidate deployment being a different potential deployment plan. The candidate deployment plans can represent all possible deployments. Any candidate deployment plan that does not comply with the policy rules is discarded. The different deployment plans can each be automatically represented by a corresponding logic version.

Each different version of the logic can be evaluated by one or more of the optimization algorithms. The optimization algorithms can each apply a different optimization technique, such as ant colony optimization, particle swarm optimization, etc. to the topology. When using different optimization techniques, the same one or more optimization criteria (also referred to as optimization goal(s)) are used. The optimization goal can be defined by the policy rules entered by the user using orchestration policy intake module 120. Some examples of optimization goals include, without limitation, minimal number of devices running, minimal and even CPU consumption per device, minimal power consumption, scaling up or down for production changes, batch process changes (e.g., for producing cookies vs. cupcakes), cybersecurity hardening in the event of a suspected attack, thermal response, minimizing resource costs, etc.

A result of the optimization techniques applied to the respective versions can be compared for determining which is the optimal logic version. When a plurality of optimization techniques is used, the result of the optimization techniques can be based on a selected optimization technique that seems to perform best for industrial system infrastructure 101 or can be based on a combination or statistical analysis (e.g., average, mean, maximum, minimum, etc.) of two or more of the optimization techniques used. The result of each optimization technique can include selection of a logic version that performs best and an indication of achievement of the optimization goal by the selected logic version. For example, if the optimization goal is minimal CPU consumption per device, the output of the optimization technique evaluation of a logic version can be CPU consumption per device. The logic version that best meets the optimization goal would be selected for that technique and could be compared to or compared with the results of any other optimization techniques being applied. Optimization techniques that provide outlier results can be disregarded.

The selected logic version provides a desired state of industrial system infrastructure 101 and is output by optimal orchestration module 140 to deployment service backend 170. The logic version is software. The logic version can be provided as a system state machine, which can be provided in a descriptive format, such as JSON™ YMAL™, or TOSCA™. The system state machine provides a desired system state of industrial system infrastructure 101. The system state machine defines and describes an optimal deployment of applications on the hardware devices, including for different states of the industrial system infrastructure 101.

Deployment service backend 170 includes memory 171, an orchestration engine 174, and a system monitor 178. Deployment service backend 170 receives the optimal logic version from orchestration service backend 130 and stores it as a system state machine 172 in memory 171. System state machine 172 is accessed by or provided to orchestration engine 174. Orchestration engine 174 can be included in a computer-integrated manufacturing system (CIMS) and can include orchestration tools, including, for example, a deployment engine. The CIMS and/or orchestration engine 174 can utilize logic provided by system state machine 172 to call orchestration tools, such as deployment engine 176. Deployment engine 176 can implement deployments defined by system state machine 172 on industrial system infrastructure 101. For example, an application described by the system state machine 172 can be deployed on a deployment target 180 identified by system state machine 172.

System state machine 172 can have a format this compatible with orchestration engine 174 and deployment engine 176. This allows orchestration engine 174 and deployment engine 176 to use and implement the logic represented by system state machine 172.

System state machine 172 can describe an initial deployment for the complete industrial system infrastructure 101. Deployment engine 176 can implement the initial deployment, thus configuring the complete industrial system infrastructure 101 based on system state machine 172.

Deployment engine 176 can use orchestration tools, such as Kubernetes™ Ansisble™, WASM, proprietary tools, etc. for implementing deployment tasks based on system state machine 172.

It is noted that currently available orchestration tools, such as Kubernetes™ Ansible™ or the like, do not provide logic or a system state machine of a complete industrial system infrastructure. Rather, such tools perform tasks based on logic provided to it for deployment of workloads to a hardware component of container. The logic is configured for a specific scenario in which the industrial system infrastructure operates, such as a specific industry, factory, business, or needs of a customer. When a change is made to the industrial system infrastructure, the logic provided to the orchestration tool would need to be changed in order to accommodate that change. Some examples of changes that would provoke a need to update the logic include addition or removal of a device, change of goals to be achieved (such as due to a change in policy), or change in high availability and/or failure recovery strategies (such as due to a change in policy).

However, since the logic is customized for the specific scenario in which the industrial system infrastructure operates, developers are needed to update the logic. The developers need expertise about the scenario in which the industrial system infrastructure operates, expertise in information technologies, familiarity and understanding of the logic's code, and technical skill to update the logic. A developer having this knowledge and these skills is needed to make even a minor change. In certain orchestration applications, the logic is hardcoded, further complicating the process of updating the logic. For similar reasons, maintenance of an orchestrator can be resource and time consuming.

The current disclosure provides and systems and methods, including intake tool frontend 110 and orchestration services backend 130, to automate and standardize a process of generating and updating system state machine 172. Intake tool frontend 110 provides a user-friendly GUI that can be used to generate and update the topology of complete industrial system infrastructure 101, including configuration of each asset and policy rules of industrial system infrastructure 101. The topology has a standardized format that can be processed by orchestration services backend 130 for generating logic, e.g., in the format of system state machine 172. System state machine 172 is compatible with orchestration engine 174 and deployment engine 176, enabling their use and implementation of system state machine 172.

System monitor 178 is configured to monitor industrial system infrastructure 101, including status of its hardware and applications and compliance with its policy rules. For example, system monitor 178 can monitor the CPU usage of each hardware component and monitor application health status, etc. System monitor 178 can aggregate information about monitoring results, which can be provided for further data analysis.

In a situation in which system monitor detects that a problem associated with industrial system infrastructure 101 (e.g., in or caused by industrial system infrastructure 101) has arisen, such as, without limitation, overload of a hardware component or an application, an elevated temperature of a hardware component, defective or reduced output from industrial system infrastructure 101, lost power, lost communication, errors and/or abnormal status of a hardware component while running an application, etc., this information can be provided to input validation module 138 in orchestration service backend 130. Input validation module 138 can repeat cross input validation to cause an adjustment to one or more assets or policy rules of the topology of the complete industrial system infrastructure 101. Examples of some adjustments include moving an application from one hardware component to another hardware component or removing a hardware component that had an elevated temperature. In one or more embodiments, the adjustment can be automatic or can include user intervention. Varying degrees of user intervention can be used, such as prompting a user to perform the adjustment or recommending an adjustment contingent upon user approval. The degree of user intervention needed or allowed can be configurable. Once input validation module 138 validates the modified topology, the modified topology can be submitted to optimal orchestration module 140 so that new logic can be provided to deployment service backend 170.

System monitor 178 can further report real time information about status of industrial system infrastructure 101 to display tool frontend 190.

Display tool frontend 190 outputs the information received from system monitor 178 to a display device 192, thus providing a real time view of the status of the industrial system infrastructure. A user can view the system status information of a user interface of display device 192. The user can view the displayed information on a display device 192 of a mobile device or a fixed computer.

The user can receive alarms via display device 192 when system monitor 178 detects a problem, such as a compromised hardware component or software errors. The display device can also indicate when the when the problem is resolved and the alarm is cleared, e.g., by repeating the validation process and optimization process performed by orchestration services backend 130. The display device can also indicate to the user when the problem needs manual support, such as when a hardware component has lost power and needs to be reconnected, there is high frequency of false alarms, or detected errors indicate the need for an upgrade.

System monitor 178 can detect changes to industrial system infrastructure 101, such as addition, removal of, or upgrade of a hardware component or application. For example, system monitor 178 will detect that a hardware component was added to industrial system infrastructure 101 when a hardware component that had lost power is reconnected to power, scaling up or down of the number of hardware components, removal of a hardware component, and installation of a software upgrade. In response to detecting a change to industrial system infrastructure 101, system monitor 178 will alert input validation module 138 about the change. Input validation module 138 will then prompt the user to update the topology via intake tool frontend 110. The validation process is then repeated by validation modules 131, thus validating the updated topology. After its validation, the updated topology is processed by optimal orchestration module 140 to update the logic. The updated logic is provided to deployment services backend 170. The updated logic can be provided to deployment engine 176 to update the deployment.

A user can reconfigure the topology at any time via the GUI provided by intake tool frontend 110, even after the topology has been represented by logic, causing deployment in industrial system infrastructure 101. Thus, a user can change the policy rules that are used for generating and/or optimizing the logic. Each time the user updates the topology, a new validation process is performed by optimization modules 131, and the logic is updated and optimized by optimal orchestration module 140. The updated logic is provided to deployment engine 176 (e.g., as system state machine 172), causing updates to deployment of hardware components and applications in industrial system infrastructure 101.

Thus, intake tool frontend 110 and orchestration services backend 130 automate (with the option for a configurable amount of user intervention) and standardize the process for generating logic to be used by orchestration engine 174.

Intake tool frontend 110 and orchestration services backend 130 are configurable to adapt to different types of industries and businesses. Configurations can include configuration of the libraries used by intake modules 111, configuration of validation rules used by validation modules 131, and configuration of parameters and increments (for incremental changes) used by optimal orchestration module 140. Different business owners can configure and use intake tool frontend 110 and orchestration services backend 130 to create different state machines for use by an orchestration engine, such as orchestration engine 174. Flexibility is provided so that hardware components and applications can be added or removed from industrial system infrastructure 101 followed by optimization of the deployment within industrial system infrastructure 101, and a user can update the topology of industrial system infrastructure 101 via the GUI provided by intake tool frontend 110 at any time.

With reference now to FIG. 2, shown is a flowchart demonstrating implementation of the various exemplary embodiments. It is noted that the order of operations shown in FIG. 2 is not required, so in principle, the various operations may be performed out of the illustrated order. Also, certain operations may be skipped, different operations may be added or substituted, some operations may be performed in parallel instead of strictly sequentially, or selected operations or groups of operations may be performed in a separate application following the embodiments described herein.

Blocks 204 and 210 are directed to a basic implementation of the method. Blocks 202, 206, 208, 212, 214, 216, and 218 show optional operations of the disclosed method that can be included in one or more embodiments of the disclosure (as indicated by the doted lines).—The operations described by any combination of blocks 202, 206, 208, 212, 214, 216, and 218 can be included in the disclosed method.

Beginning with block 204, hardware user selections that define a plurality of hardware components of the industrial system infrastructure as a complete system are received. Additionally, a plurality of application user selections and policy user selections are received. The application user selections define a plurality of applications to be deployed on the plurality of hardware components. The policy user selections define rules for deployment of the plurality of hardware components and applications. At block 210, generation of logic is caused or prompted. The logic defines a plan for deployment of the applications on the plurality of hardware components in compliance with the rules for deployment. The logic is configured to guide deployment of the applications on the plurality of hardware components.

At block 202, a GUI is provided for receiving (at block 204) the hardware user selections, the application user selections, and the policy user selections.

At block 206, the hardware user selections, the application user selections, and/or the policy user selections are individually validated.

At block 208, the hardware user selections, the application user selections, and the policy user selections are validated in view of one another. When a validation issue is detected (meaning an invalid condition is detected), such as a conflict between two or more different input selections of the hardware user selections, the application user selections, and/or the policy user selections are individually validated, block 208 can invoke block 218. Block 218 prompts a user to make revisions to one or more of the user selections to correct the detected validation issue. The method can continue at block 204, at which the user makes the revisions and revised user selections are received at block 204.

It is envisioned that in one or more embodiments, block 206 can be configured to invoke 218 in response to detecting a validation issue when individually validating a user selection of any of the input selections of the hardware user selections, the application user selections, and/or the policy user selections.

At block 212, the logic is optimized to represent a deployment that best satisfies one or more optimization goals.

At block 214, notification of a problem associated with the industrial system infrastructure is received. Block 214 then invokes block 208 to validate the user selections and the user policy user selections in view of one another. It is envisioned that in one or more embodiments, block 214 can invoke block 206 in addition to or alternatively to invocation of block 208.

At block 216, it is detected that one or more of the hardware component, application, and/or policy user selections were updated. Block 216 then invokes block 208 to validate the user selections and the user policy user selections in view of one another. It is envisioned that in one or more embodiments, block 216 can invoke block 206 in addition to or alternatively to invocation of block 208. Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart(s) and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

With reference to FIG. 3, a block diagram of an example processing system 300 is shown, which provides an example configuration of one or more computing systems used by computing components of an orchestration system (such as orchestration system 100 shown in FIG. 1. One such processing system 300 is illustrated in FIG. 3. In various embodiments, processing system 300 may be a server, a mainframe computer system, a workstation, a network computer, a desktop computer, a laptop, a handheld computer, or the like, and/or include one or more of a field-programmable gate array (FPGA), application specific integrated circuit (ASIC), microcontroller, microprocessor, or the like. Processing system 300 is only one example of a suitable system and is not intended to suggest any limitation as to the scope of use or functionality of embodiments of the disclosure described herein. Processing system 300 can be implemented using hardware, software, and/or firmware. Regardless, processing system 800 is capable of being implemented and/or performing functionality as set forth in the disclosure.

Additionally, all or portions of the computing components of the orchestration system could be configured as software, and processing system 300 could represent such portions. Processing system 300 is only one example of a suitable system and is not intended to suggest any limitation as to the scope of use or functionality of embodiments of the disclosure described herein. Processing system 300 can be implemented using hardware, software, and/or firmware. Regardless, processing system 300 is capable of being implemented and/or performing functionality as set forth in the disclosure.

Processing system 300 is shown in the form of a general-purpose computing device. Processing system 300 includes a processor 302, storage 304, an input/output (I/O) interface (I/F) 306 that can communicate with an internal component, such as a user interface 310, and optionally one or more external components 308, such as another processing device of the orchestration system 100 or a processing device of an industrial system infrastructure, such as industrial system infrastructure 101 shown in FIG. 1.

The processor 302 can include, for example, a CPU, a programmable logic device (PLD), microprocessor, a discrete signal processor (DSP), a microcontroller, a field programmable gate array (FPGA), an application specific integrated circuit (ASIC), and/or other discrete or integrated logic circuitry having similar processing capabilities. The processor 302 and the storage 304 can be included in components provided in the FPGA, ASIC, microcontroller, or microprocessor, for example.

Storage 304 can include, for example, volatile and non-volatile memory for storing data temporarily or long term, and for storing programmable instructions executable by the processor 302. Storage 304 can be a removable (e.g., portable) memory for storage of program instructions. I/O I/F 306 can include an interface and/or conductors to couple to the one or more internal components, such as user interface 310 and/or external component(s) 308.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the block diagram block or blocks.

Embodiments of the processing components of the orchestration system may be implemented or executed by one or more computer systems, such as a microprocessor. One processing system 300, or multiple instances thereof, can be included within modules of the orchestration system. In various embodiments, processing system 300 may include one or more of a microprocessor, an FPGA, application specific integrated circuit (ASIC), microcontroller. The processing system 300 can be provided as an embedded device. Portions of the processing system 300 can be provided externally, such by way of a virtual, centralized, and/or cloud-based computer.

Processing system 300 is only one example of a suitable system and is not intended to suggest any limitation as to the scope of use or functionality of embodiments of the disclosure described herein. Regardless, processing system 300 is capable of being implemented and/or performing any of the functionality set forth hereinabove.

Processing system 300 may be described in the general context of computer system-executable instructions, such as program modules, being executed by a computer system. Generally, program modules may include routines, programs, objects, components, logic, data structures, and so on that perform particular tasks or implement particular abstract data types.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. A method for customizing orchestration of an industrial system infrastructure, the method comprising:
receiving hardware user selections defining a plurality of hardware components of the industrial system infrastructure as a complete system;
receiving application user selections defining applications to be deployed on the plurality of hardware components;
receiving policy user selections defining rules for deployment of the plurality of hardware components and applications; and
causing generation of logic that defines a plan for deployment of the applications on the plurality of hardware components in compliance with the rules for deployment, wherein the logic is configured to guide deployment of the applications on the plurality of hardware components.

2. The method of claim 1, further comprising outputting the logic to guide the deployment of the applications on the plurality of hardware components.

3. The method of claim 1, further comprising providing a graphical user interface (GUI) for receiving the hardware user selections, the application user selections, and the policy user selections, and the GUI allows a user to select the hardware user selections, application user selections, and policy user selections from one or more repositories of information.

4. The method of claim 1, wherein the hardware user selections define connections between hardware components and the topology indicates how the hardware components are connected with each other.

5. The method of claim 1, further comprising performing a cross-validation process, which includes validating the hardware user selections, the application user selections, and the policy user selections in view of one another.

6. The method of claim 5, further comprising prompting a user to revise one or more of the hardware user selections, the application user selections, and the policy user selections, followed by repeating the cross-validation process.

7. The method of claim 2, further comprising optimizing the logic to best satisfy one or more optimization goals before outputting the logic.

8. The method of claim 7, wherein the one or more optimization goals are included in the policy user selections.

9. The method of claim 1, further comprising individually validating the hardware user selections, the application user selections, and/or the policy user selections.

10. The method of claim 5, further comprising receiving notification of a problem associated with the industrial system infrastructure and causing the cross-validation process to be repeated responsive to receipt of the notification of the problem, and causing the generation of the logic to be repeated.

11. The method of claim 5, further comprising receiving an update to at least one of the hardware user selections, the application user selections, and the policy user selections, causing the cross-validation process to be repeated responsive to receipt of the update, and causing the generation of the logic to be repeated.

12. A system for customizing orchestration of an industrial system infrastructure, the system comprising:
a memory configured to store programmable instructions; and
a processing device in communication with the memory, wherein the processing device, upon execution of the programmable instructions is configured to:
receive hardware user selections defining a plurality of hardware components of the industrial system infrastructure as a complete system;
receive application user selections defining applications to be deployed on the plurality of hardware components;
receive policy user selections defining rules for deployment of the plurality of hardware components and applications; and
cause generation of logic that defines a plan for deployment of the applications on the plurality of hardware components in compliance with the rules for deployment, wherein the logic is configured to guide deployment of the applications on the plurality of hardware components.

13. The system of claim 12, wherein the processing device, upon execution of the programmable instructions is further configured to output the logic to guide the deployment of the applications on the plurality of hardware components.

14. The system of claim 12, wherein the processing device, upon execution of the programmable instructions is further configured to provide a graphical user interface (GUI) for receiving the hardware user selections, the application user selections, and the policy user selections, and the GUI allows a user to select the hardware user selections, application user selections, and policy user selections from one or more repositories of information.

15. The system of claim 12, wherein the hardware user selections define connections between hardware components and the topology indicates how the hardware components are connected with each other.

16. The system of claim 12, wherein the processing device, upon execution of the programmable instructions is further configured to perform a cross-validation process, which includes validating the hardware user selections, the application user selections, and the policy user selections in view of one another.

17. The system of claim 16, wherein the processing device, upon execution of the programmable instructions is further configured to prompt a user to revise one or more of the hardware user selections, the application user selections, and the policy user selections, followed by repeating the cross-validation process.

18. The system of claim 13, wherein the processing device, upon execution of the programmable instructions is further configured to optimize the logic to best satisfy one or more optimization goals before outputting the logic.

19. The system of claim 18, wherein the one or more optimization goals are included in the policy user selections.

20. The system of claim 12, wherein the processing device, upon execution of the programmable instructions is further configured to individually validate the hardware user selections, the application user selections, and/or the policy user selections.

21. The system of claim 16, wherein the processing device, upon execution of the programmable instructions is further configured to receive notification of a problem associated with the industrial system infrastructure and causing the cross-validation process to be repeated responsive to receipt of the notification of the problem, and cause the generation of the logic to be repeated.

22. The system of claim 16, wherein the processing device, upon execution of the programmable instructions is further configured to receive an update to at least one of the hardware user selections, the application user selections, and the policy user selections, cause the cross-validation process to be repeated responsive to receipt of the update, and cause the generation of the logic to be repeated.
